(19) United States
(12) Patent Application Publication
(10) Pub. No.: US 2026/0086249 A1
(43) Pub. Date: Mar. 26, 2026

(54) COMBINED CORRECTION FOR SATELLITE PHASE CENTER OFFSET (PCO) AND DIFFERENTIAL CODE BIAS (DCB)

(71) Applicant: QUALCOMM Incorporated, San Diego, CA (US)

(72) Inventor: Min WANG, Tustin, CA (US)

(21) Appl. No.: 18/892,959

(22) Filed: Sep. 23, 2024

(51) Int. Cl. G01S 19/44; G01S 19/40

(52) U.S. Cl. CPC G01S 19/44; G01S 19/40

(57) ABSTRACT

Techniques for global navigation satellite system (GNSS) positioning of a GNSS device using error correction may include obtaining phase center offset (PCO) error correction data for a frequency band used by a GNSS satellite to transmit a GNSS signal received by the GNSS device. A PCO error correction approximation may be determined based at least in part on a difference between a Z-axis component of the PCO error correction data and a Z-axis component of a PCO reference point for a position of the GNSS satellite. Techniques may include determining a combined error correction value for PCO and differential code bias (DCB) error correction based at least in part on the PCO error correction approximation and DCB error correction data for the frequency band, and performing a positioning operation, using the combined error correction value, for determining a location of the GNSS device.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously driven vehicle is in and may further benefit from sub-meter-level positioning information that enables it to determine where that vehicle is located within the lane.

High-accuracy positioning of a mobile device may involve the use of a precise positioning engine (PPE) at the mobile device to generate high-accuracy positioning information based on GNSS measurements and error correction data. The error correction data may be received at the mobile device and may be in a format such as State-Space Representation (SSR). The mobile device may use SSR correction data for all GNSS satellites and frequency bands for which it obtained GNSS measurements, and the high-accuracy positioning information (e.g., position estimate of the mobile device) can be based on the GNSS measurements, corrected by the corresponding SSR correction data.

### BRIEF SUMMARY

An example method of global navigation satellite system (GNSS) positioning of a GNSS device using error correction, according to this description, comprises obtaining, at a first device, phase center offset (PCO) error correction data for a frequency band used by a GNSS satellite to transmit a GNSS signal received by the GNSS device. The method may also include determining, with the first device, a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite. The method may furthermore include determining, with the first device, a combined error correction value for PCO and differential code bias (DCB) error correction, the combined error correction value based at least in part on the PCO error correction approximation and DCB error correction data for the frequency band. The method may in addition include performing a positioning operation with the first device, using the combined error correction value, for determining a location of the GNSS device.

An example device, according to this description, may include one or more transceivers, one or more memories, and one or more processors communicatively coupled with the one or more transceivers and the one or more memories. The one or more processors may be configured to: obtain phase center offset (PCO) error correction data for a frequency band used by a global navigation satellite system (GNSS) satellite to transmit a GNSS signal received by a GNSS device. The one or more processors further may be configured to determine a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite. The one or more processors further may be configured to determine a combined error correction value for PCO and DCB error correction, the combined error correction value based at least in part on the PCO error correction approximation and differential code bias (DCB) error correction data for the frequency band. The one or more processors further may be configured to perform a positioning operation, using the combined error correction value, for determining a location of the GNSS device.

An example apparatus, according to this description, comprises include means for obtaining phase center offset (PCO) error correction data for a frequency band used by a GNSS satellite to transmit a GNSS signal received by the GNSS device. The apparatus may also include means for determining a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite. The apparatus may furthermore include means for determining a combined error correction value for PCO and DCB error correction, the combined error correction value based at least in part on the PCO error correction approximation and differential code bias (DCB) error correction data for the frequency band. The apparatus may in addition include means for performing a positioning operation, using the combined error correction value, for determining a location of the GNSS device.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system in which a mobile device (e.g., a global navigation satellite system (GNSS) device) can use the techniques provided herein for precise positioning with State-Space Representation (SSR), according to an embodiment.

FIG. 2 is a simplified diagram of a GNSS system, according to an embodiment.

FIG. 3 is a table of correction data that can be used by a precise positioning engine (PPE) for high-precision position estimates, according to embodiments herein.

FIG. 4 is a flow diagram of an example process of applying satellite (SV) phase center offset (PCO) values to perform error correction.

FIG. 5 is a message flow diagram of a first process performed to enable a GNSS device to determine a GNSS-based position using combined PCO and differential code bias (DCB) correction, according to an embodiment.

FIG. 6 is a message flow diagram of a second process performed to enable a GNSS device to determine a GNSS-based position using combined PCO and (DCB) correction, according to an embodiment.

FIGS. 7A and 7B are graphs comparing error correction using separate SV PCO and DCB SSR values with error correction using a combined PCO and DCB value in accordance with embodiments herein.

FIG. 8 is a flow diagram of a method of GNSS positioning of a GNSS device using error correction, according to an embodiment.

FIG. 9 is a block diagram of an embodiment of a GNSS device.

FIG. 10 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, A GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, a GNSS device may be able to accurately estimate its position using measurements of GNSS signals transmitted on different GNSS frequency bands by multiple different GNSS satellites, along with correction data corresponding to those frequency bands and satellites. In particular, a precise positioning engine (PPE) executed by the mobile device may perform GNSS positioning using a high-precision GNSS positioning technique, such as precise point positioning (PPP) or real-time kinematic (RTK) positioning, by performing error correction on GNSS measurements taken at the mobile device. State-space representation (SSR) is a type of correction data that may be used in such positioning.

SSR correction data may be particularly advantageous over alternatives such as observation-space representation (OSR) because each error component may be represented individually rather than using “lump sum” error correction. This means that some error correction may be performed if the mobile device can only obtain a portion of the error components. Moreover, some SSR error components may be provided for free, whereas OSR error correction may require a paid service.

There are, however, some drawbacks to using SSR correction for GNSS positioning. In addition to the overhead required to transmit/receive SSR correction data, the application of various SSR data types to perform error correction on GNSS data is not always straightforward. For example, the satellite (SV) phase center offset (PCO) correction model is quite complex, which can not only require a relatively large amount of processing resources but can also result in potential degradation in performance if not correctly implemented.

Embodiments address these and other issues by providing techniques by which an SV PCO approximation may be used and combined with differential code bias (DCB) correction. According to some embodiments, this single combined value can replace traditional SV PCO and DCB correction in SSR correction data. This combined value may be determined by a device providing SSR correction data or by a device receiving the SSR correction data, depending on the desired functionality. Because of the reduced processing requirements of using this combined value, it can be advantageous in either case.

Particular aspects of the subject matter described in this disclosure can be implemented to realize one or more of the following potential advantages. In some examples, by combining SV PCO correction with differential code bias (DCB) correction, the described techniques can be used to provide these SSR correction types without the high processing requirements (e.g., million instructions per second (MIPS) requirements) needed to apply SV PCO correction using traditional techniques. Moreover, according to some embodiments, the combined SV PCO and DCB correction can be conveyed in a single float value which use significantly less memory in overhead (e.g., 75% less) than SV PCO and DCB correction in traditional SSR. These and other advantages will be apparent to a person of ordinary skill in the art in view of the embodiments described below.

Various embodiments are provided in detail hereafter, following a review of applicable technology.

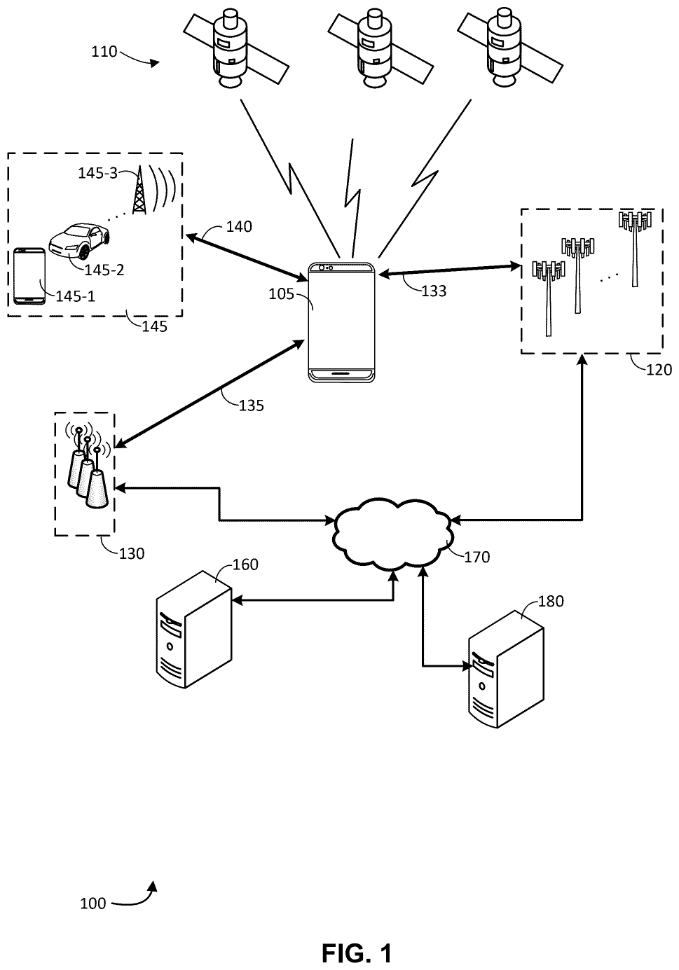

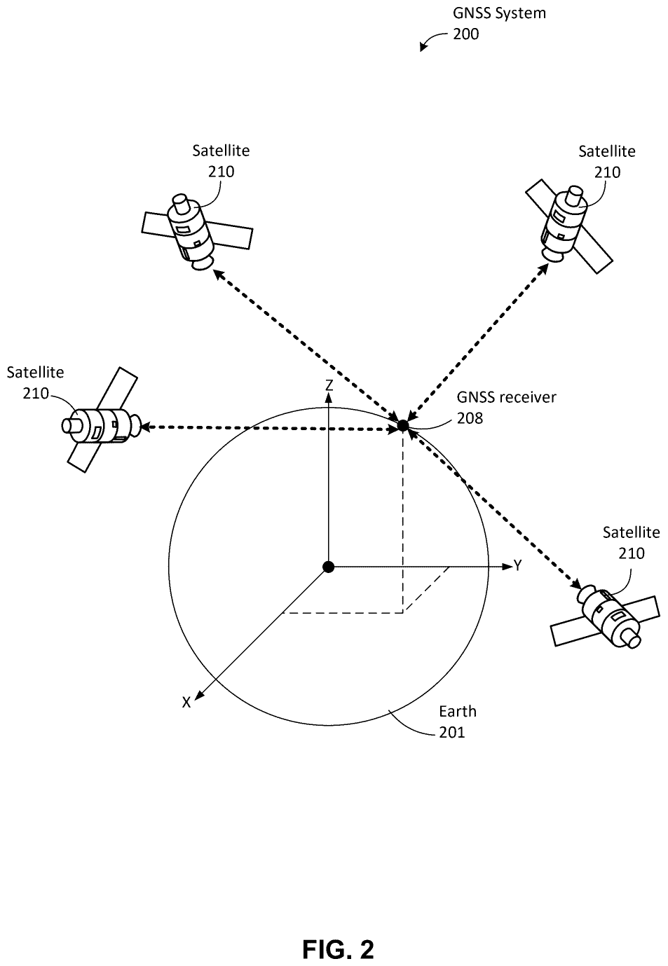

FIG. 1 is a simplified illustration of a positioning system 100 in which a mobile device 105, location server 160, and/or other components of the positioning system 100 can use the techniques provided herein for determining and using combined SV PCO and DCB correction data, according to an embodiment. The techniques described herein may be implemented by one or more components of the positioning system 100. The positioning system 100 can include a mobile device 105; one or more satellites 110 (also referred to as space vehicles (SVs)) for a GNSS such as the global positioning system (GPS), GLONASS (GLO), Galileo (GAL), or BeiDou Navigation Satellite System (BDS); base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding particular location estimation techniques are discussed in more detail with regard to FIG. 2.

In this example, FIG. 1 illustrates the mobile device 105 as a smartphone device. However, mobile devices capable of performing the techniques described herein may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of devices as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as a friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding the GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201. Put generally, the GNSS system 200 enables an accurate GNSS position fix of the GNSS receiver 208, which receives RF signals from GNSS satellites 210 (which may correspond with satellites 110 of FIG. 1) from one or more GNSS constellations. The types of GNSS receiver 208 used may vary, depending on the application. In some embodiments, for instance, the GNSS receiver 208 may comprise a standalone device or component incorporated into another device (e.g., mobile device 105 of FIG. 1). In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 in a given GNSS constellation, and many different types of GNSS systems with corresponding constellations. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, determining the position of a GNSS receiver 208 in three dimensions may rely on determining the distance between the GNSS receiver 208 and four or more satellites 210. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 210 and the GNSS receiver 208 may be determined using precise measurements made by the GNSS receiver 208 of a difference in time from when an RF signal is transmitted from the respective satellite 210 to when it is received at the GNSS receiver 208. To help ensure accuracy, not only does the GNSS receiver 208 need to accurately determine when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide a positioning accuracy for the GNSS receiver 208 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites; the X-band, used by the military and for RADAR applications; and the Ku-band (primarily downlink communication and the Ka-band (primarily uplink communications), the Ku and Ka bands used for communications satellites. The L-band is defined by IEEE as the frequency range from 1 to 2 GHZ. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As previously noted, precise positioning (e.g., RTK or PPP positioning) may utilize error correction provided by an error correction service. Error correction is typically provided using SSR or OSR. As previously noted, OSR utilizes a format in which a “lump sum” of error components for carrier phase and pseudorange measurements are provided, typically from a local physical reference station positioning reference signal (PRS). SSR, on the other hand, provides correction of individual error components, such as orbit, clock, SV PCO, and DCB. When SSR transmits enough information, the accuracy of resulting positioning estimates based on SSR can be comparable to the accuracy achieved using OSR. Furthermore, free SSR (with regional or global coverage) is often available for at least some GNSS frequency bands from services such as Quasi-Zenith Satellite System (QZSS) Centimeter Level Augmentation Service (CLAS), QZSS Multi-GNSS Advanced Orbit and Clock Augmentation-Precise Point Positioning (MADOCA-PPP), Galileo (GAL) High Accuracy Service (HAS), and BDS PPP-B2b.

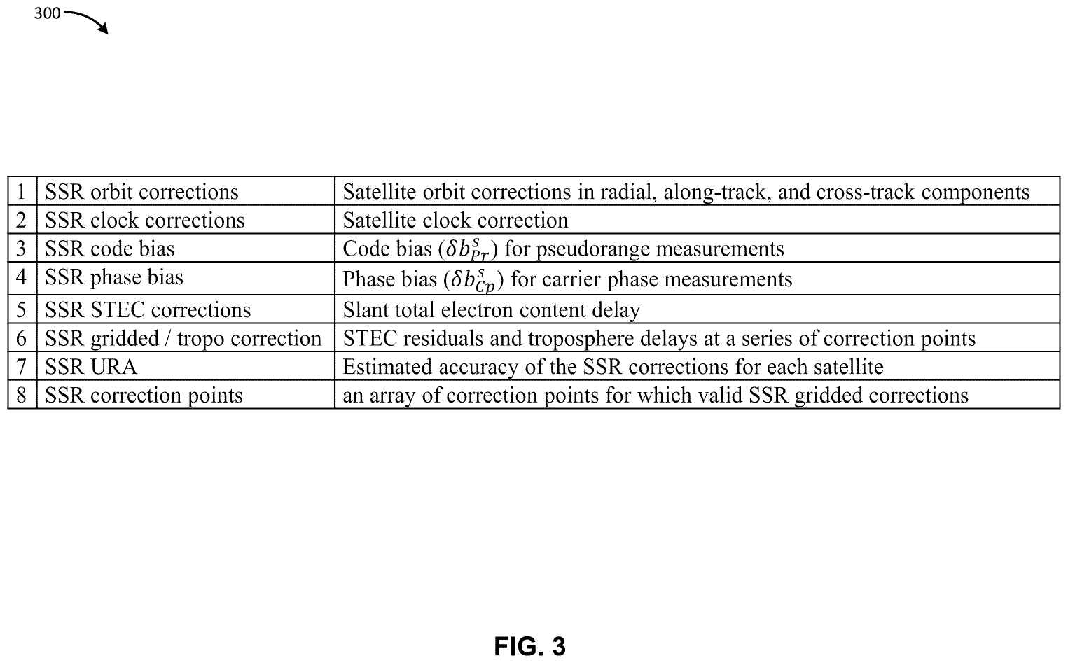

FIG. 3 is an illustration of Table 300, showing the various data fields of SSR data, according to some embodiments. Specifically, SSR data may include eight types of data, each of which may be referred to herein with the term “SSR” followed by the numeral indicated in the first column of Table 300. Thus, SSR1 comprises satellite orbit corrections, SSR2 comprises deadline clock corrections, SSR3 comprises code bias (e.g., differential code bias (DCB)), SSR4 comprises phase bias, SSR5 comprises slants total electron content (STEC) delay correction (e.g., ionospheric delay correction), SSR6 (which may be referred to herein generally as tropospheric delay correction) comprises STEC residuals and tropospheric delays, SSR7 comprises an estimated accuracy value (e.g., user range accuracy (URA)) of other SSR data (e.g., SSR1-SSR6), and SSR8 comprises correction points for which valid SSR gridded corrections are applicable. In error correction, SSR may be provided as a vector with one or more of the data fields shown in Table 300, where each element of the vector represents a different data field.

Generally put, the more SSR elements that are used for positioning, the more accurate the positioning solution can be. For example, SSR1-SSR3 may be considered “standard” SSR for PPP solutions. Although this can result in increasing GNSS-based positioning accuracy from 5-10 m to roughly 2.5-5 m, the accuracy is case-dependent (e.g., based on conditions like current ionosphere error), and convergence time may be relatively long if only SSR1-SSR3 are used. The standard SSR elements (SSR1-SSR3) are broadcast to the public for free, allowing for free increased accuracy over traditional GNSS positioning. But, many applications require higher accuracy and/or lower convergence times, in which case additional SSR elements are needed.

SV PCO (also referred to herein simply as “PCO”) and DCB are typically treated separately for purposes of error correction. In the table 300, for example, the code bias of SSR3 can be assumed to be equivalent to DCB, and there is no standardized definition regarding SV PCO in SSR, which is often obtained with a model. However, as noted, performing error correction for GNSS-based positioning using these data types is not always straightforward.

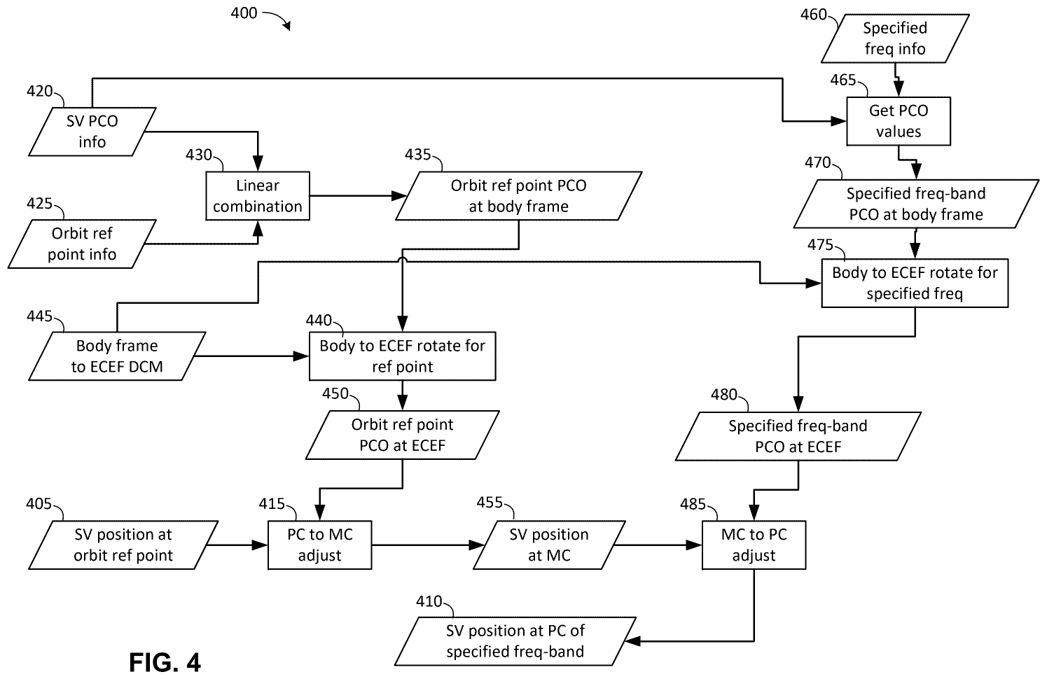

FIG. 4, for example, is a flow diagram of an example process 400 of applying SV PCO values (e.g., from SSR data received from an SSR data source) to perform error correction, which a positioning engine of a GNSS device may implement. In some aspects, the process 400 may be considered a model for applying PCO error correction using PCO values obtained from hard-coded or proprietary messages (e.g., non-standard SSR correction).

As can be seen, implementation of the process 400 is somewhat complicated. The position of a given satellite may be obtained from ephemeris data (shown at block 405). However, it may need to be adjusted to reflect a position for a given frequency band accurately. SV PCO correction can provide this per-frequency adjustment, ultimately enabling a determination of SV position at a phase center (PC) of a specified frequency band (block 410). However, as illustrated in the process 400, it can take various data and processes to be able to perform this determination. The satellite position information provided at block 405 in the ephemeris data is provided using a PC reference. However, the process 400 includes performing a PC to mass center (MC) transformation (block 415) of this data.

To be able to perform this transformation, the data and operations at blocks 420-450 may need to be obtained and performed. This includes obtaining SV PCO information for a given satellite (block 420), which may be obtained from hard-coded or proprietary messages (e.g., non-standard SSR correction), and applied using the process of FIG. 4. This can be combined with orbit reference point information for broadcast ephemeris satellite position (block 425, which may be provided in GNSS interface control documents (ICDs)) using a linear combination (block 430) (e.g., an iono-free combination) to determine an orbit reference point for a body frame (or “body-fixed” frame) of the satellite (block 435). This is then transformed to the ECEF coordinate frame (block 440) using a direction cosign matrix (DCM) (block 445), producing an orbit reference point PCO in the ECF coordinate frame (block 450) that can be used to perform the PC to MC (block 415) of the satellite position information provided at block 405. This adjustment results in an MC satellite position (block 455).

Blocks 460-475 are used to obtain a specified frequency band PCO at ECEF (block 480) that can be used to transform the MC satellite position at block 455 from MC to PC, shown at block 485, which results in the desired satellite position at PC of a specified frequency band (block 410). To do this, for a given frequency band (block 460) PCO values may be obtained (blocks 465) from the PCO information of a satellite (block 420), resulting in the specified frequency band PCO at the body frame of the satellite (block 470). The DCM at block 445 can then be used to transform the specified frequency PCO from a body frame to ECEF (block 475) to produce the specified frequency band PCO at ECEF (block 480).

SV PCO correction applied in the range domain is similarly complicated. It can involve taking a difference of the SV PCO of each frequency band with a SV PCO of a reference point for the frequency band, rotating it to ECEF (e.g. using a DCM), and projecting the resulting vector onto a line of sight (LOS) vector between the satellite and the GNSS device.

Ultimately, applying the SV PCO correction can be difficult and processing-intensive. Any error in the processes provided above can result in degradation in a resulting GNSS-based positioning. Further, various calculations of the process 400 can be particularly challenging. For example, determining the DCM to transform coordinates from a body-fixed frame to the ECEF frame includes determining the sun's location in real time, to adjust for the rotation of the satellite's solar panels toward the sun. These processing demands, along with time-based positioning requirements for a given application, can result in a relatively high MIPS requirement that some GNSS devices may be unable to meet.

Embodiments herein address these and other issues by combining SV PCO and DCB error correction in a single value. As described in more detail below, this can result in a process that is easier to implement and requires less processing than the process 400 (and similar processes) for applying SV PCO error correction. For example, the DCM matrix may not be needed, thereby obviating any need to determine the location of the sun in real time. Further, embodiments may also use a single float value rather than four float values used in traditional SSR error correction data (e.g., a 3×1 float vector for SV PCO and float value for DCB, per frequency band), reducing the amount of memory and overhead needed to store and communicate separate SV PCO and DCB values (e.g., by 75%). These reduced processing and memory requirements can allow for SV PCO and DCB error correction to be implemented at lower-costs GNSS devices that may not have otherwise met the MIPS requirements to be able to perform such error correction with conventional SSR. Further, because the implementation itself is easier (versus the process 400 of FIG. 4, for example), there is less likelihood of implementation error that would result in unexpected GNSS-based positioning performance degradation.

Embodiments can start with a simplified SV PCO correction calculation based on the satellite body-fixed frame definition and the related user range error (URE). As noted above, SV PCO error correction data is typically provided in SSR in the frame of the satellite body. Further, as noted in Table 1 below, the Z-axis component of a satellite body-fixed frame is the GNSS antenna boresight direction of the satellite, essentially pointing to the center of the earth.

| | Definition |
|---|---|
| Origin | Mass center of the satellite |
| X-axis | Perpendicular to the X axis and the Z axis |
| Y-axis | Parallel to the rotation axis of the solar panels |
| Z-axis | GNSS antenna boresight direction |
| | (the direction pointing to the earth center) |

### Table 1: Definition of Satellite Body-Fixed Frame

Further, for SV PCO correction, the user range error (URE) (the error in the calculated distance between the GNSS satellite and the GNSS receiver) for a given frequency band, Li, can be computed as:

$$URE = \sqrt{{( 0.98 * {pco}_{Li , Z} )}^{2} + {0.141}^{2} ( {pco}_{Li , X}^{2} + {pco}_{Li , Y}^{2} )} \qquad ( Eqn . 1 )$$

where pco_{Li,Z}, pco_{Li,Z}, and pco_{Li,Z} are SV PCO error correction values for X, Y, and Z axes, respectively, in the satellite body-fixed frame for the frequency band Li, which are typically which are typically needed in traditional PCO mode.

Based on the Eqn. 1 and satellite body-frame definition, the Z component of URE typically has over 90% (and often over 95%) of the impact on the overall URE. This means that SV PCO error correction for the frequency band Li can be approximated as:

$${PCO}_{Li} \approx - ( {pco}_{Li , Z} - {pco}_{ref , Z} ) \qquad ( Eqn . 2 )$$

where pco_{Li,Z}, is the satellite SV PCO Z component at the Li band (e.g., in meters), and pco_{ref,Z}, is the satellite PCO Z component at a satellite (SV) reference position (e.g., in meters). Thus, the SV PCO error correction value, PCO_{Li}, can be represented with a single value (e.g., float value) rather than the three values (3×1 vector of float values) in traditional SSR.

Further, the SV PCO value can be combined with DCB error correction, which can further reduce the number of values needed to relay SV PCO and DCB error correction to a single value. For example, for a DCB value, DCBᵢ, the following equation can be used:

$${δ}_{i} = {PCO}_{Li} - {DCB}_{i} \approx ( {pco}_{Li , Z} - {pco}_{ref , Z} ) - {DCB}_{i} \qquad ( Eqn . 3 )$$

where δᵢ is the combined SSR correction for SV PCO for a frequency band i (in meters).

It can be noted, however, that some embodiments may not combine the approximated SV PCO (Eqn. 2) with DCB error correction. In some instances, for example, it may be beneficial to use the approximated SV PCO (Eqn. 2) without combining it with DCB error correction. As such, some embodiments may utilize one or both of these error correction values separately.

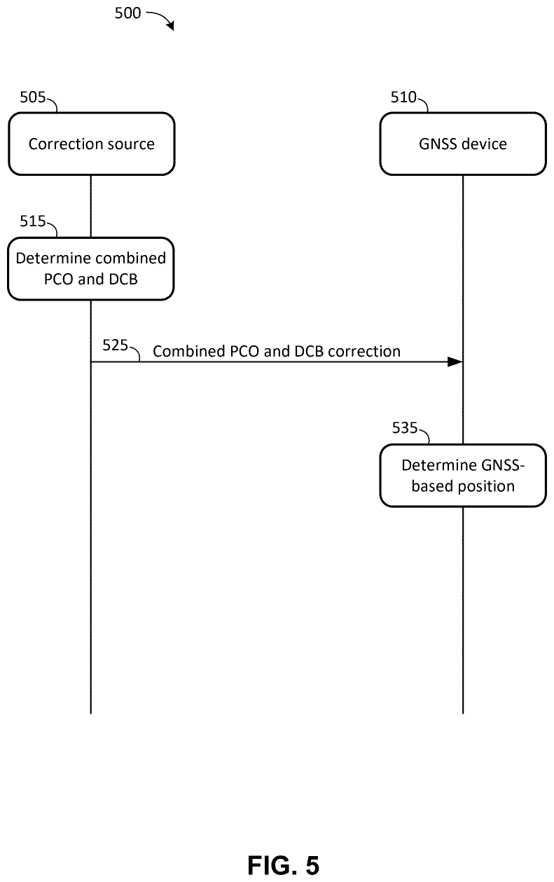

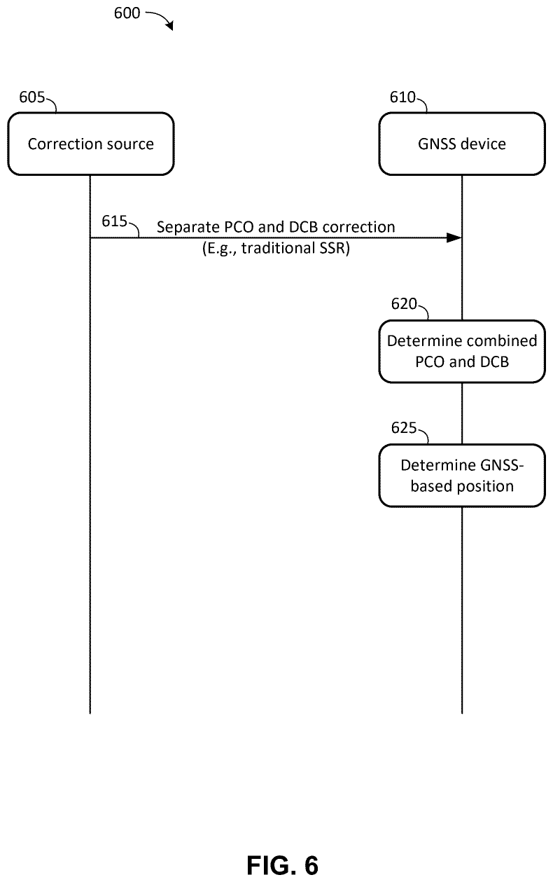

The functionality of determining the combined SSR correction, 8%, may be performed by server of a correction service provider, for example, and subsequently provided to a GNSS device (e.g., via wireless communication, such as via a cellular network). That said, according to some embodiments, a GNSS device itself may perform this functionality after receiving separate SV PCO and DCB values (e.g., from traditional SSR data provided by a correction source). FIGS. 5 and 6, discussed below, provide further details.

FIG. 5 is a message flow diagram of a first process 500, executed by a correction source 505 and a GNSS device 510, performed to enable the GNSS device 510 to determine a GNSS-based position using combined PCO and DCB correction, according to an embodiment. In this example, the process 500 may comprise the correction for source 505 determining a combined PCO and DCB error correction value, as indicated at block 515. As described in the embodiments above, this may involve obtaining traditional SV PCO values and performing an approximation of PCO_{Li}, as shown in Eqns. 2 and 3, above. The correction source 505 may then provide the combined PCO and DCB correction to the GNSS device 510, as indicated by arrow 525. According to some embodiments, this combined value may be included, for example, as part of SSR error correction values, and the combined PCO and DCB correction may be provided instead of (or in addition to) traditional SV PCO and DCB values included in SSR correction data. Using this combined value, the GNSS device 510 may determine its GNSS-based position, as indicated at block 535, including the error correction enabled by the combined PCO and DCB correction received from the correction source 505.

FIG. 6 is a message flow diagram of a second process 600, executed by a correction source 605 and a GNSS device 610, performed to enable the GNSS device 610 to determine a GNSS-based position using combined PCO and DCB correction, according to an embodiment. In contrast to the process 500 of FIG. 5, the process 600 of FIG. 6 has the GNSS device 610, rather than the correction source 605, determining the combined PCO and DCB value. More specifically, after receiving separate PCO and DCB correction values from the correction source 605, as indicated by arrow 615, the GNSS device 610 may determine its own combined SV PCO and DCB value, as indicated at block 620. The information received from the correction source 605, indicated by arrow 615, may therefore be traditional SSR correction data, according to some embodiments. The GNSS device 610 may determine its GNSS-based position, as indicated at block 625, including the error correction enabled by the combined SV PCO and DCB correction it determined at block 620.

It can be noted that FIGS. 5 and 6 provide a simplified overview of how a correction source and GNSS device may interact to enable the determination of a combined PCO and DCB value for GNSS-based positioning of the GNSS device. A person of ordinary skill in the art will appreciate that other functions may need to be performed by the correction source and/or GNSS device to enable this positioning, including performing GNSS measurements, updating a positioning engine, etc., some of which have been described previously. Further, a person of ordinary skill in the art will appreciate how variations may be made to the processes of FIGS. 5 and 6 to provide the same or similar functionality in a given application.

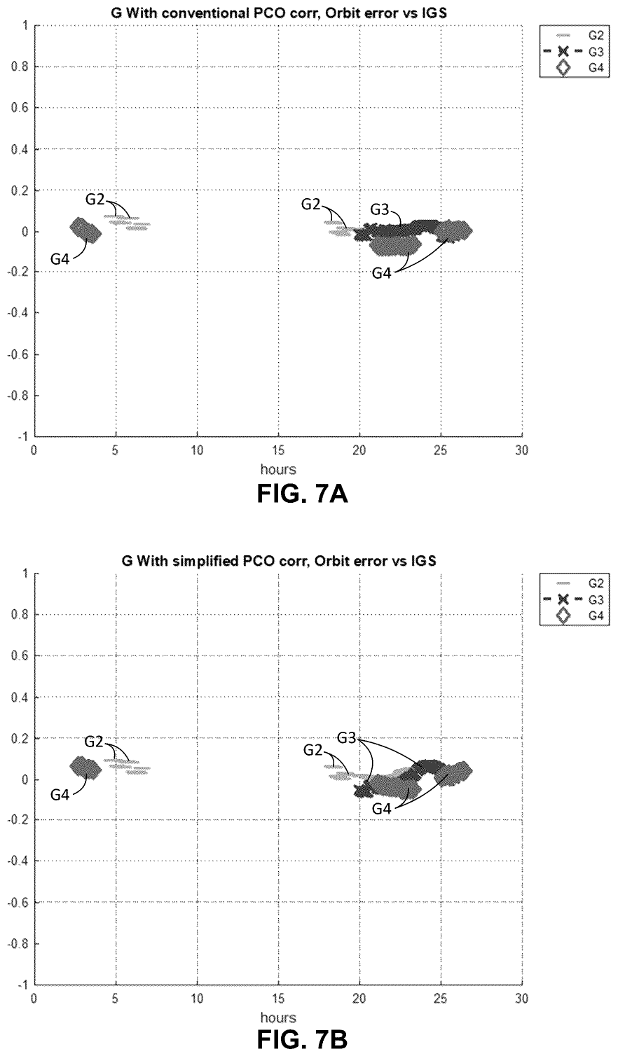

FIGS. 7A and 7B are graphs of simulation results that use an example data set to compare error correction using separate SV PCO and DCB SSR values with error correction using a combined PCO and DCB value in accordance with embodiments herein. In particular, FIG. 7A shows a graph of GNSS-based positioning error (orbit URE) for satellites G2, G3, and G4 during a time period using separate SV PCO and DCB SSR values, and FIG. 7B shows a similar graph in which a combined PCO and DCB value is determined in the manner described herein and used for error correction. As can be seen, using a combined PCO and DCB value results in comparable error cancellation performance. Moreover, using the combined PCO and DCB value over 32 satellites with three signal bands results in significantly reduced memory usage: 1536 bytes using the conventional approach with separate values, and 384 bytes using combined PCO and DCB values.

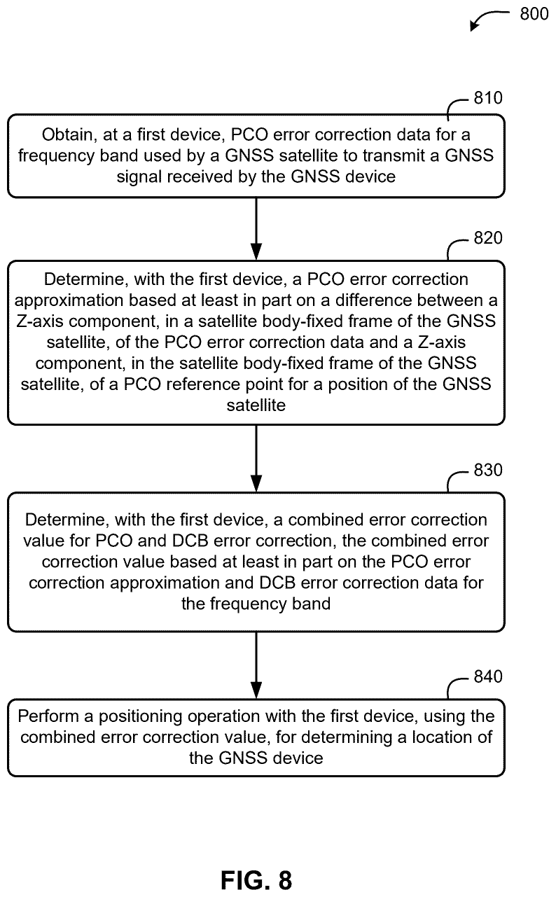

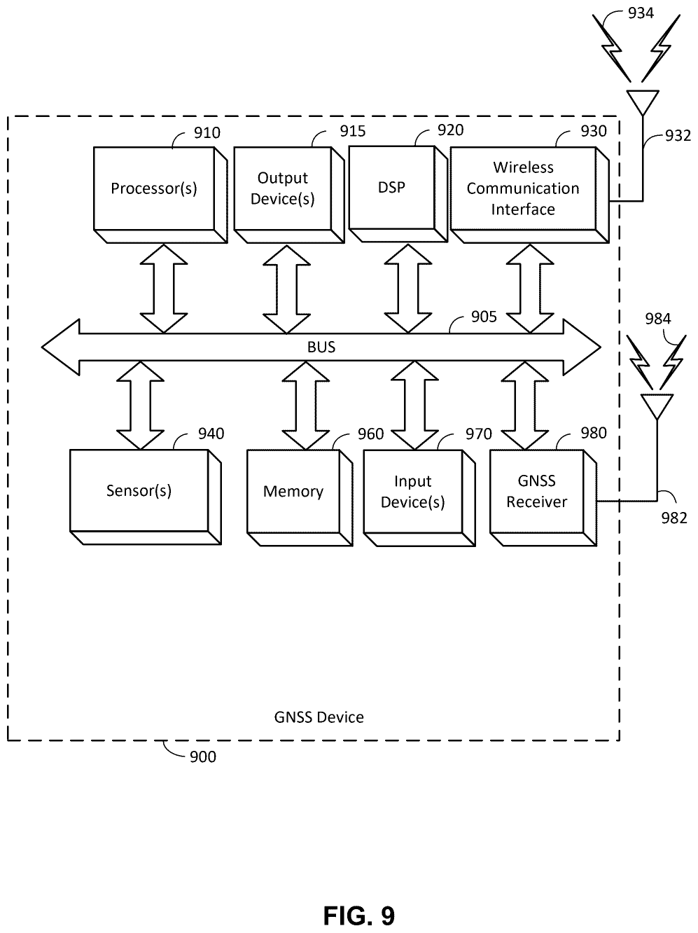

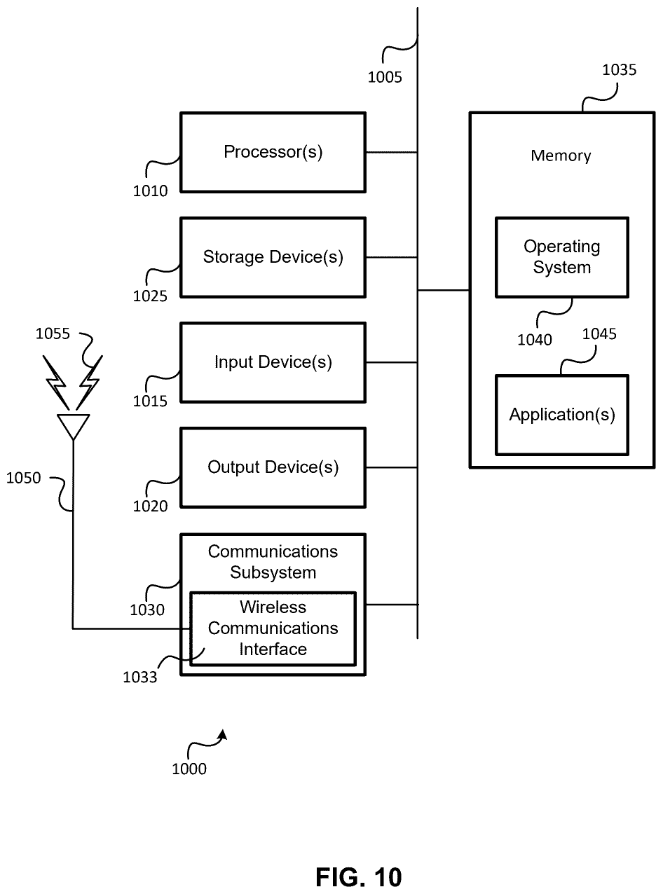

FIG. 8 is a flow diagram of a method 800 of GNSS positioning of a GNSS device using error correction, according to some embodiments. The method may be performed, for example, by a device that may use SSR and/or other information to determine a combined PCO and DCB error correction value, as described in the embodiments above. As noted in the disclosure above with regard to FIGS. 5 and 6, for example, this may comprise an error correction source and/or a GNSS device. The air correction source itself may comprise a GNSS device, server, or other device configured to provide error correction information to the GNSS device. As such, and means and/or structure for performing the functionality of one or more blocks of the method 800 may comprise software and/or hardware components of a GNSS device or a computer system. An example GNSS device is provided in FIG. 9, and an example computer system is provided in FIG. 10, both of which are discussed in more detail below.

The method 800 may begin with the functionality at block 810, which includes obtaining, at a first device, PCO error correction data for a frequency band used by a GNSS satellite to transmit a GNSS signal received by the GNSS device. As noted elsewhere herein, PCO values used to determine PCO error correction may be obtained from hard-coated or proprietary messages, which may be a type of non-standard SSR correction. This PCO error correction data, according to some embodiments, may be the same PCO error correction data used for traditional PCO error correction.

Means for performing functionality at block 810 may comprise a bus 905, one or more processors 910, a DSP 920, a wireless communication interface 930, one or more sensors 940, one or more memories 960, a GNSS receiver 980, and/or other components of a GNSS device 900, as illustrated in FIG. 9. Additionally or alternatively, means for performing functionality at block 810 may comprise a bus 1005, one or more processors 1010, one or more input devices 1015, a communications subsystem 1030 (which may include a wireless communications interface 1033), one or more memories 1035, and/or other components of a computer system 1000, as illustrated in FIG. 10.

At block 820, the functionality comprises determining, with the first device, a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite. As mentioned elsewhere herein, a Z-axis of the GNSS satellite in the satellite body-fixed frame may comprise an axis that extends from the satellite to the center of the earth. According to some embodiments, the approximation based on the difference between the Z-axis component of the PCO error correction data and the Z-axis component of the PCO reference point for a position of the GNSS satellite may correspond with Eqn. 2 above. As also noted herein, according to some embodiments, the PCO error correction approximation excludes (i) an X-axis component, in the satellite body-fixed frame of the GNSS satellite, of the PCO error correction data and (ii) a Y-axis component of the PCO error correction data, in the satellite body-fixed frame of the GNSS satellite.

Means for performing functionality at block 820 may comprise a bus 905, one or more processors 910, one or more memories 960, a GNSS receiver 980, and/or other components of a GNSS device 900, as illustrated in FIG. 9. Additionally or alternatively, means for performing functionality at block 820 may comprise a bus 1005, one or more processors 1010, one or more memories 1035, and/or other components of a computer system 1000, as illustrated in FIG. 10.

The functionality at block 830 comprises determining, with the first device, a combined error correction value for PCO and DCB error correction, the combined error correction value based at least in part on the PCO error correction approximation and differential code bias (DCB) error correction data for the frequency band. According to some embodiments, this determination may correspond with performing Eqn. 3 above.

Means for performing functionality at block 830 may comprise a bus 905, one or more processors 910, one or more memories 960, a GNSS receiver 980, and/or other components of a GNSS device 900, as illustrated in FIG. 9. Additionally or alternatively, means for performing functionality at block 830 may comprise a bus 1005, one or more processors 1010, one or more memories 1035, and/or other components of a computer system 1000, as illustrated in FIG. 10.

The functionality at block 840 comprises performing a positioning operation with the first device, using the combined error correction value, for determining a location of the GNSS device. The nature of this positioning operation may vary, depending on the device performing this function. For example, according to some embodiments, the first device may comprise a server (e.g., a correction source). In such embodiments, performing the positioning operation with the first device may comprise sending information comprising the combined error correction value from the server to the GNSS device. This may be performed, for example, as part of a positioning session or other type of positioning service conducted between the server and GNSS device. According to some embodiments, the first device may comprise the GNSS device. In such embodiments, performing the positioning operation with the first device may comprise determining, with the GNSS device, a position of the GNSS device based at least in part on the combined error correction value. This can include, for example, applying the combined error correction value to a position of the GNSS device determined using GNSS-based positioning. In such embodiments, the position of the GNSS device further may be based at least in part on one or more measurements made by the GNSS device of the GNSS signal received by the GNSS device. Additionally or alternatively, obtaining the PCO error correction data may comprise obtaining the PCO error correction data from SSR data received by the GNSS device from a server. As noted elsewhere herein, PCO error correction may not be included in traditional SSR data, in some instances, and therefore the PCO error correction data may come in the form of non-standard SSR data.

Means for performing functionality at block 840 may comprise a bus 905, one or more processors 910, a DSP 920, a wireless communication interface 930, one or more sensors 940, one or more memories 960, a GNSS receiver 980, and/or other components of a GNSS device 900, as illustrated in FIG. 9. Additionally or alternatively, means for performing functionality at block 840 may comprise a bus 1005, one or more processors 1010, one or more input devices 1015, a communications subsystem 1030 (which may include a wireless communications interface 1033), one or more memories 1035, and/or other components of a computer system 1000, as illustrated in FIG. 10.

FIG. 9 is a block diagram of an embodiment of a GNSS device 900, which can be utilized as described herein above (e.g., in association with FIGS. 1-8). In some embodiments, GNSS device 900 may implement a positioning engine (e.g., a PPE) that can perform some or all of the functionality of the method 800 of FIG. 8. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, the GNSS device 900 may be incorporated into another device, such as a cell phone, vehicle, etc., as previously noted.

The GNSS device 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The GNSS device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The GNSS device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 900 to communicate with other devices as described in the embodiments above. The wireless communication interface 930 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 900 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the GNSS device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The GNSS device 900 may further include and/or be in communication with a memory 960. The memory 960 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the GNSS device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the GNSS device 900 (and/or processor(s) 910 or DSP 920 within GNSS device 900). In some embodiments, then, such code and/or instructions can be used to configure and/or adapt a general-purpose computer (or other device) to perform one or more operations in accordance with the described methods.

FIG. 10 is a block diagram of an embodiment of a computer system 1000, which may be used, in whole or in part, to provide the functions of various devices described herein, including a computer, server, base station, correction source (e.g., correction source 505 of FIG. 5 and/or correction source 605 of FIG. 6), or a combination thereof. It should be noted that FIG. 10 is meant only to provide a generalized illustration of various components, any or all of which may be utilized as appropriate. Further, computer system 100 may be capable of performing some or all of the functions of method 800 of FIG. 8. FIG. 10 broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network and/or any other electronic devices described herein. Hence, the communications subsystem 1030 may be used to receive and send data as described in the embodiments herein. In some embodiments, the computer system 1000 may comprise a GNSS receiver, which may be a discrete component (not shown) and/or may be integrated into another component of the computer system 1000.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of global navigation satellite system (GNSS) positioning of a GNSS device using error correction, the method comprising: obtaining, at a first device, phase center offset (PCO) error correction data for a frequency band used by a GNSS satellite to transmit a GNSS signal received by the GNSS device; determining, with the first device, a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite; determining, with the first device, a combined error correction value for PCO and DCB error correction, the combined error correction value based at least in part on the PCO error correction approximation and differential code bias (DCB) error correction data for the frequency band; and performing a positioning operation with the first device, using the combined error correction value, for determining a location of the GNSS device.

Clause 2: The method of clause 1, wherein the first device comprises a server, and wherein performing the positioning operation with the first device comprises sending information comprising the combined error correction value from the server to the GNSS device.

Clause 3: The method of clause 1, wherein the first device comprises the GNSS device, and wherein performing the positioning operation with the first device comprises determining, with the GNSS device, a position of the GNSS device based at least in part on the combined error correction value.

Clause 4: The method of any one of clause 3, wherein obtaining the PCO error correction data comprises obtaining the PCO error correction data from state-space representation (SSR) data received by the GNSS device from a server.

Clause 5: The method of any one of clauses 3-4, wherein the position of the GNSS device is further based at least in part on one or more measurements made by the GNSS device of the GNSS signal received by the GNSS device.

Clause 6: The method of any one of clauses 1-5, wherein the PCO error correction approximation excludes (i) an X-axis component, in the satellite body-fixed frame of the GNSS satellite, of the PCO error correction data and (ii) a Y-axis component of the PCO error correction data, in the satellite body-fixed frame of the GNSS satellite.

Clause 7: A device comprising: one or more transceivers; one or more memories; and one or more processors communicatively coupled with the one or more transceivers and the one or more memories, the one or more processors configured to: obtain phase center offset (PCO) error correction data for a frequency band used by a global navigation satellite system (GNSS) satellite to transmit a GNSS signal received by a GNSS device; determine a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite; determine a combined error correction value for PCO and DCB error correction, the combined error correction value based at least in part on the PCO error correction approximation and differential code bias (DCB) error correction data for the frequency band; and perform a positioning operation, using the combined error correction value, for determining a location of the GNSS device.

Clause 8: The device of clause 7, wherein the device comprises a server, and wherein, to perform the positioning operation, the one or more processors are configured to send, via the one or more transceivers, information comprising the combined error correction value from the server to the GNSS device.

Clause 9: The device of clause 7, wherein the device comprises the GNSS device, and wherein, to perform the positioning operation, the one or more processors are configured to determine a position of the GNSS device based at least in part on the combined error correction value.

Clause 10: The device of clause 9, wherein, to obtain the PCO error correction data, the one or more processors are configured to obtain the PCO error correction data from state-space representation (SSR) data received by the GNSS device from a server.

Clause 11: The device of any one of clauses 9-10, further comprising one or more GNSS receivers, and wherein the one or more processors are configured to base the position of the GNSS device further at least in part on one or more measurements made of the GNSS signal, using the one or more GNSS receivers.

Clause 12: The device of any one of clauses 7-11, wherein, to determine the PCO error correction approximation, the one or more processors are configured to exclude, from the error correction approximation, (i) an X-axis component, in the satellite body-fixed frame of the GNSS satellite, of the PCO error correction data and (ii) a Y-axis component of the PCO error correction data, in the satellite body-fixed frame of the GNSS satellite.

Clause 13: An apparatus for global navigation satellite system (GNSS) positioning of a GNSS device using error correction, the apparatus comprising: means for obtaining phase center offset (PCO) error correction data for a frequency band used by a GNSS satellite to transmit a GNSS signal received by the GNSS device; means for determining a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite; means for determining a combined error correction value for PCO and DCB error correction, the combined error correction value based at least in part on the PCO error correction approximation and differential code bias (DCB) error correction data for the frequency band; and means for performing a positioning operation, using the combined error correction value, for determining a location of the GNSS device.

Clause 14: The apparatus of clause 13, wherein the apparatus comprises a server, and wherein the means for performing the positioning operation comprises means for sending information comprising the combined error correction value from the server to the GNSS device.

Clause 15: The apparatus of clause 13, wherein the apparatus comprises the GNSS device, and wherein the means for performing the positioning operation comprises means for determining a position of the GNSS device based at least in part on the combined error correction value.

Clause 16: The apparatus of clause 15, wherein the means for obtaining the PCO error correction data comprises means for obtaining the PCO error correction data from state-space representation (SSR) data received by the GNSS device from a server.

Clause 17: The apparatus of any one of clauses 15-16, wherein the means for determining the position of the GNSS device is configured to further base the determined position at least in part on one or more measurements made by the GNSS device of the GNSS signal received by the GNSS device.

Clause 18: The apparatus of any one of clauses 13-17, wherein the means for determining the PCO error correction approximation is configured to exclude, from the PCO error correction approximation, (i) an X-axis component, in the satellite body-fixed frame of the GNSS satellite, of the PCO error correction data and (ii) a Y-axis component of the PCO error correction data, in the satellite body-fixed frame of the GNSS satellite.

Clause 19: A non-transitory computer-readable medium storing instructions, the instructions comprising code for performing the method of any one of clauses 1-6.

What is claimed is:

1. A method of global navigation satellite system (GNSS) positioning of a GNSS device using error correction, the method comprising:
obtaining, at a first device, phase center offset (PCO) error correction data for a frequency band used by a GNSS satellite to transmit a GNSS signal received by the GNSS device;
determining, with the first device, a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite;
determining, with the first device, a combined error correction value for PCO and differential code bias (DCB) error correction, the combined error correction value based at least in part on the PCO error correction approximation and DCB error correction data for the frequency band; and
performing a positioning operation with the first device, using the combined error correction value, for determining a location of the GNSS device.

2. The method of claim 1, wherein the first device comprises a server, and wherein performing the positioning operation with the first device comprises sending information comprising the combined error correction value from the server to the GNSS device.

3. The method of claim 1, wherein the first device comprises the GNSS device, and wherein performing the positioning operation with the first device comprises determining, with the GNSS device, a position of the GNSS device based at least in part on the combined error correction value.

4. The method of claim 3, wherein obtaining the PCO error correction data comprises obtaining the PCO error correction data from state-space representation (SSR) data received by the GNSS device from a server.

5. The method of claim 3, wherein the position of the GNSS device is further based at least in part on one or more measurements made by the GNSS device of the GNSS signal received by the GNSS device.

6. The method of claim 1, wherein the PCO error correction approximation excludes (i) an X-axis component, in the satellite body-fixed frame of the GNSS satellite, of the PCO error correction data and (ii) a Y-axis component of the PCO error correction data, in the satellite body-fixed frame of the GNSS satellite.

7. A device comprising:
one or more transceivers;
one or more memories; and
one or more processors communicatively coupled with the one or more transceivers and the one or more memories, the one or more processors configured to:
obtain phase center offset (PCO) error correction data for a frequency band used by a global navigation satellite system (GNSS) satellite to transmit a GNSS signal received by a GNSS device;
determine a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite;
determine a combined error correction value for PCO and differential code bias (DCB) error correction, the combined error correction value based at least in part on the PCO error correction approximation and DCB error correction data for the frequency band; and
perform a positioning operation, using the combined error correction value, for determining a location of the GNSS device.

8. The device of claim 7, wherein the device comprises a server, and wherein, to perform the positioning operation, the one or more processors are configured to send, via the one or more transceivers, information comprising the combined error correction value from the server to the GNSS device.

9. The device of claim 7, wherein the device comprises the GNSS device, and wherein, to perform the positioning operation, the one or more processors are configured to determine a position of the GNSS device based at least in part on the combined error correction value.

10. The device of claim 9, wherein, to obtain the PCO error correction data, the one or more processors are configured to obtain the PCO error correction data from state-space representation (SSR) data received by the GNSS device from a server.

11. The device of claim 9, further comprising one or more GNSS receivers, and wherein the one or more processors are configured to base the position of the GNSS device further at least in part on one or more measurements made of the GNSS signal, using the one or more GNSS receivers.

12. The device of claim 7, wherein, to determine the PCO error correction approximation, the one or more processors are configured to exclude, from the error correction approximation, (i) an X-axis component, in the satellite body-fixed frame of the GNSS satellite, of the PCO error correction data and (ii) a Y-axis component of the PCO error correction data, in the satellite body-fixed frame of the GNSS satellite.

13. An apparatus for global navigation satellite system (GNSS) positioning of a GNSS device using error correction, the apparatus comprising:
means for obtaining phase center offset (PCO) error correction data for a frequency band used by a GNSS satellite to transmit a GNSS signal received by the GNSS device;
means for determining a PCO error correction approximation based at least in part on a difference between a Z-axis component, in a satellite body-fixed frame of the GNSS satellite, of the PCO error correction data and a Z-axis component, in the satellite body-fixed frame of the GNSS satellite, of a PCO reference point for a position of the GNSS satellite;
means for determining a combined error correction value for PCO and differential code bias (DCB) error correction, the combined error correction value based at least in part on the PCO error correction approximation and DCB error correction data for the frequency band; and
means for performing a positioning operation, using the combined error correction value, for determining a location of the GNSS device.

14. The apparatus of claim 13, wherein the apparatus comprises a server, and wherein the means for performing the positioning operation comprises means for sending information comprising the combined error correction value from the server to the GNSS device.

15. The apparatus of claim 13, wherein the apparatus comprises the GNSS device, and wherein the means for performing the positioning operation comprises means for determining a position of the GNSS device based at least in part on the combined error correction value.

16. The apparatus of claim 15, wherein the means for obtaining the PCO error correction data comprises means for obtaining the PCO error correction data from state-space representation (SSR) data received by the GNSS device from a server.

17. The apparatus of claim 15, wherein the means for determining the position of the GNSS device is configured to further base the determined position at least in part on one or more measurements made by the GNSS device of the GNSS signal received by the GNSS device.

18. The apparatus of claim 13, wherein the means for determining the PCO error correction approximation is configured to exclude, from the PCO error correction approximation, (i) an X-axis component, in the satellite body-fixed frame of the GNSS satellite, of the PCO error correction data and (ii) a Y-axis component of the PCO error correction data, in the satellite body-fixed frame of the GNSS satellite.
